(19) United States
(12) Patent Application Publication
(10) Pub. No.: US 2009/0321512 A1
(43) Pub. Date: Dec. 31, 2009

(54) NAVIGATION DEVICE

(76) Inventor: Arved Hübler, Chemnitz (DE)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(21) Appl. No.: 12/309,907

(22) PCT Filed: Jul. 4, 2007
(86) PCT No.: PCT/EP2007/056764

§ 371 Date: Feb. 2, 2009

(30) Foreign Application Priority Data
Aug. 25, 2006 (DE) 10 2006 039 927.7

(51) Int. Cl. G06F 17/00

(52) U.S. Cl. 235/375; 235/486; 235/487

(57) ABSTRACT

The invention relates to a navigation device comprising a read device and at least one information card, the latter containing a code arrangement that can be read by the read device and that controls the navigation device to arrive at a predefined destination. The code arrangement consists of conductive organic polymers.

The invention relates to a navigation device for arriving at a predetermined destination.

Today navigation systems are widely used both in vehicles and in mobile devices such as PDAs, notebooks or mobile telephones. In order to select a destination for the navigation system, it is as a rule necessary to make a selection from the entries which are stored in the navigation system, for instance street names or special establishments. Therefore this input entails a certain expenditure, and inexperienced users often have difficulties in this respect.

EP-B-0 770 217 therefore describes a data input card for navigation equipment for making it easier to arrive at a predetermined destination, the top surface of which card is divided into at least two different fields, the first of the fields being disposed on a predetermined area of the surface and comprising a bar code. A reading device for the insertion of the data input card is connected to the navigation device. The reading device recognises the location coordinates which are stored in the bar code and delivers these in an appropriate coding to the navigation system, which can then calculate the route to the input location.

However an optical reading device is required for reading the bar code, and this is relatively complex and therefore also expensive to produce. In addition, simple bar code readers having a slot reader with CCD elements entail the problem of the optical elements becoming soiled very quickly through paper dust. The actual bar code can also become impossible to read through overwriting, dirt, adhesive labels, etc.

The object of the invention is therefore to present a code arrangement for an information card for controlling a navigation device which can be read with a simple and inexpensive reading device. It should also be possible to produce the information card and, in particular, the code arrangement thereof in a simple and inexpensive manner.

This object is solved according to the invention by the features of Claim 1.

The navigation device according to the invention comprises a reading device and at least one information card, the information card containing a code arrangement which can be read by the reading device and serving to control the navigation device to arrive at a predetermined destination. Here the code arrangement consists of conductive organic polymers.

An inexpensive reading device which reads out the code arrangement, for example by means of an inductive, a capacitive or an ohmic coupling, is in particular possible through the code arrangement. There is also the possibility of printing the code arrangement and in this connection using in particular mass printing processes.

Further configurations of the invention constitute the subject matter of the subclaims.

According to one preferred embodiment, the information card consists of two flexible substrate layers which can consist in particular of paper or of film. The code arrangement can in this case be invisibly embedded between the two substrate layers. This results in the possibility of forming or printing the information card on its top side and/or underside in a completely free manner. PEDOT or PANI, for example, can be used as conductive organic polymers.

When compared with a bar code, the code arrangement of conductive organic polymers also has in particular the advantage of reliable readability, as the structure can be disposed in a protected manner between two substrate layers.

Further advantages and configurations of the invention are illustrated in detail in the following on the basis of the description and the drawings, in which

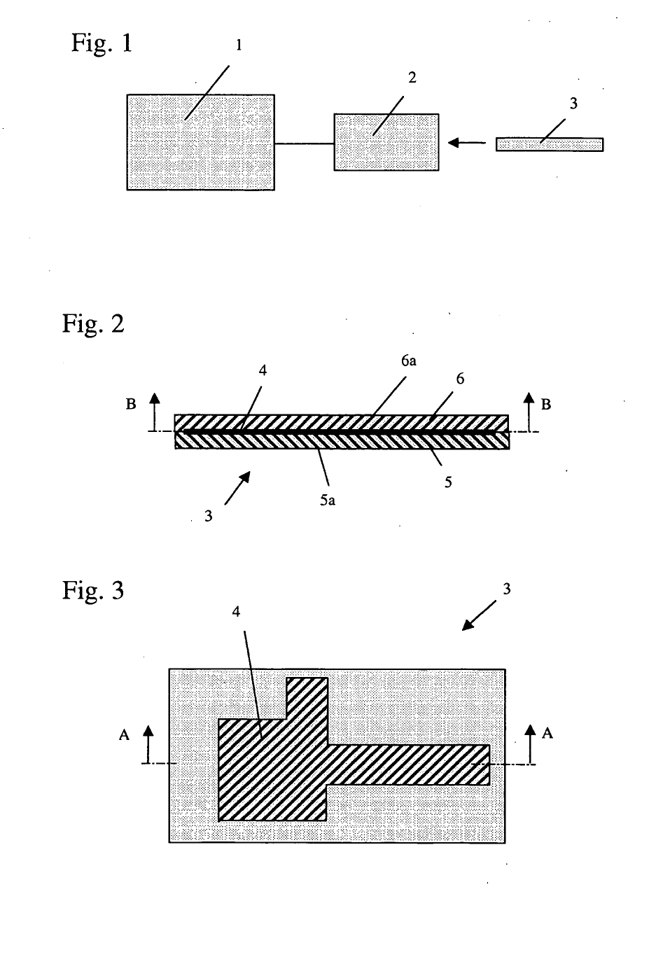

FIG. 1 is a block diagram of the navigation device with information card,

FIG. 2 is a longitudinal sectional representation along the line A-A of FIG. 3 and

FIG. 3 is a sectional representation along the line B-B of FIG. 2.

FIG. 1 shows a navigation device 1 as well as a reading device 2, the reading device 2 either being integrated into the navigation device or connectable as an external device to the navigation device. Here the connection can be effected via a cable or in a contactless manner. An information card 3 can be inserted in the reading device 2. The information card 3, which is represented in more detail in FIGS. 2 and 3, comprises a code arrangement 4 which serves to control the navigation device 1 for arriving at a certain destination.

The information card 3 preferably consists of two flexible substrate layers 5, 6 which can in particular consist of paper or film. The code arrangement 4 is advantageously invisibly embedded between the two substrate layers 5, 6, as can be seen from FIG. 2. Joining can be effected by lamination, for example, or in another way. The code arrangement 4 consists of conductive organic polymers, for example PEDOT or PANI.

The information cards can be produced particularly inexpensively if the conductive organic polymers are produced by means of a mass printing process, in particular a letterpress, an intaglio or a planographic printing process.

Once the code arrangement is embedded between the two substrates, it is possible to form or to print the top side and/or underside 6a, 5a of the information card in any desired manner, without in so doing having to keep a certain area free for a code arrangement.

Various configurations of the reading device 2 are conceivable for reading the code arrangement. For example, particular possibilities are an inductive or a capacitive coupling or even an ohmic contact.

The information card can, for example, be formed by a visiting card which simply has to be inserted in the reading device to obtain reliable guidance to the stored destination via the navigation device. If the information card is a concert ticket or a ticket for another event, it would be possible to be guided to the event location via the code arrangement. The information card could also be in the form of an advertising and shopping coupon, tourism card, etc.

1. Navigation device with a reading device and at least one information card, wherein the information card contains a code arrangement which can be read by the reading device and serves to control the navigation device to arrive at a predetermined destination, wherein the information card is a visiting card which is printed on at least one of its top, side and underside, and wherein the code arrangement comprises conductive organic polymers and is invisibly embedded between two substrate layers.

2. Navigation device according to claim 1, wherein the information card comprises at least two flexible substrate layers which consist of paper or film.

3. (canceled)

4. (canceled)

5. Navigation device according to claim 1, wherein the information card is of flexible formation.

6. Navigation device according to claim 1, wherein the conductive organic polymers comprises PEDOT.

7. Navigation device according to claim 1, wherein the conductive organic polymers comprises PANI.

8. Navigation device according to claim 1, wherein the reading device is formed such that it reads out the code arrangement by means of an inductive, a capacitive or an ohmic coupling with the information card.

9. Navigation device according to claim 1, wherein the conductive organic polymers are produced by means of a mass printing process selected from the group consisting of a letterpress, an intaglio and a planographic printing process.
